(19) United States
(12) Patent Application Publication
(10) Pub. No.: US 2012/0284720 A1
(43) Pub. Date: Nov. 8, 2012

(54) HARDWARE ASSISTED SCHEDULING IN COMPUTER SYSTEM

(75) Inventors: Harold W. Cain, III, Hartsdale, NY (US); Hubertus Franke, Cortlandt Manor, NY (US); Charles R. Johns, Austin, TX (US); James A. Kahle, Austin, TX (US); Hung Q. Le, Austin, TX (US); Ravi Nair, Briaicliff Manor, NY (US)

(73) Assignee: International Business Machines Corporation, Armonk, NY (US)

(21) Appl. No.: 13/102,389

(22) Filed: May 6, 2011

(51) Int. Cl. G06F 9/46

(52) U.S. Cl. 718/101

(57) ABSTRACT

Apparatus and methods for hardware assisted scheduling of software tasks in a computer system are disclosed. For example, a computer system comprises a first pool for maintaining a set of executable software threads, a first scheduler, a second pool for maintaining a set of active software threads, and a second scheduler. The first scheduler assigns a subset of the set of executable software threads to the set of active software threads and the second scheduler dispatches one or more threads from the set of active software threads to a set of hardware threads for execution. In one embodiment, the first scheduler is implemented as part of the operating system of the computer system, and the second scheduler is implemented in hardware.

### FIELD OF THE INVENTION

The present invention relates to computer systems and, more particularly, to hardware assisted scheduling of software tasks in such computer systems.

### BACKGROUND OF THE INVENTION

Modern applications are comprised of a large set of software threads that need to be dispatched to a finite set of hardware threads. A software thread (also referred to as a software task or, simply, task) is a unit of work specified by a programmer comprising a set of instructions that are to be executed. The programmer specifies this sequence of instructions assuming that they will be executed in sequence. A hardware thread is a hardware resource available for executing this software thread in a manner that conforms to the programmer's view that the instructions in that thread are executed in sequence. At any given time, a system may have multiple software threads that need to be executed, and a set of hardware threads on which they may execute. Scheduling software threads and assigning them to hardware threads has traditionally been the job of the operating system or OS. As is well known, an operating system is a software system including programs and data, which executes (runs) on a computer system and which manages computer hardware resources and provides common services for execution of various application software programs in accordance with such computer hardware resources. The operating system maintains one or more run queues of executable tasks and time shares this set of runnable tasks over the available hardware threads. In case a task is blocked on an asynchronous event (e.g., input/output or I/O), the task is removed from the run queue and re-entered when the blocking event completes.

Computer architectures are becoming increasingly more complex and need to address problems that arise from deeper architecture pipelines and relatively long memory latencies. One technique that has been deployed is that of simultaneous multi-threading where several hardware threads share the underlying resources of a compute core (e.g., pipelines, integer units, memory caches, load store queues, etc.). The hardware itself recognizes that a thread is stalled and prohibits dispatching of that thread until the stall has been resolved, thus temporarily giving more resources to the other hardware threads.

A typical operating system treats each hardware thread as a continuously available target onto which a task can be dispatched. However, dependent on the instruction mix and the memory reference pattern of each of the tasks executing, different assignments can result in different utilization of the underlying hardware resources. For instance, keeping too many of the hardware threads active at a given time can result in thrashing of the resources (e.g., memory cache), thus slowing the overall progress of the various dispatched tasks. In contrast, if dispatched tasks experience frequent stalls (e.g., on cache misses), then the resources are under-utilized. In addition to this observation, it is well established that software in many scenarios goes through different phases that often are shorter than the scheduling intervals exposed by the operating system and each of these phases exhibits different behavior with respect to the resource requirements.

It follows that, at any given time, there is an optimal number of hardware threads that should be active and this optimal number can switch rapidly based on the behavior of the software threads (tasks) that are executing upon the hardware threads at that time. In addition, given the potentially large number of tasks that are schedulable at a given time, the overhead of cycling through this task based on OS scheduler invocation creates suboptimal utilization. It is a known property that in order to create reuse in resources (e.g., cache), it often makes sense to “batch” tasks for a period of time. At the same time the overhead associated with scheduling (e.g., interrupt, examining the run queue, etc.) can create additional pressure on the underlying hardware.

Accordingly, it is impractical for an operating system to react to the rapid changes in the optimal number of hardware threads as well as having to dispatch and manage a large number of tasks.

### SUMMARY OF THE INVENTION

Principles of the present invention provide apparatus and methods for hardware assisted scheduling of software tasks in a computer system.

For example, in one aspect of the invention, a computer system comprises a first pool for maintaining a set of executable software threads, a first scheduler, a second pool for maintaining a set of active software threads, and a second scheduler. The first scheduler assigns a subset of the set of executable software threads to the set of active software threads and the second scheduler dispatches one or more threads from the set of active software threads to a set of hardware threads for execution. In one embodiment, the first scheduler is implemented as part of the operating system of the computer system, and the second scheduler is implemented in hardware.

Advantageously, illustrative techniques of the invention enable better task scheduling with less involvement of the operating system software and more autonomy of the hardware to optimize for better resource utilization.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a hardware assisted scheduling system and methodology, according to an embodiment of the invention.

FIG. 2 illustrates a hardware assisted scheduler, according to an embodiment of the invention.

FIG. 3 illustrates a computer system in accordance with which one or more components/steps of the techniques of the invention may be implemented, according to an embodiment of the invention.

### DETAILED DESCRIPTION OF PREFERRED EMBODIMENTS

Principles of the invention will be illustratively described herein in the context of one or more illustrative computer system architectures. However, it is to be appreciated that the principles of the invention are not limited to any particular computer system architecture and are more generally applicable to any computer system in which it would be desirable to enable better task scheduling with less involvement of the operating system software and more autonomy of the hardware to optimize for better resource utilization.

As will be described in detail herein, illustrative principles of the invention advantageously introduce an additional layer of scheduling. More particularly, illustrative principles of the invention define a software thread pool and an active thread pool, wherein the active thread pool is a subset of the software thread pool. It is the task of a software thread scheduler (e.g., OS) to assign the threads from the software thread pool onto the active thread pool. A hardware thread scheduler, which is implemented in hardware, dispatches the active threads onto the hardware threads. Illustrative principles of the invention allow for more active threads than there are hardware threads. An execution unit continuously monitors the behavior of its resources and provides information to the hardware thread scheduler which in turn uses this information to dispatch more or less active threads in order to optimize for better system performance When the execution unit experiences a long delay of one hardware thread, its associated thread is returned to the active thread pool, marked as waiting for an event and a different ready active thread can be dispatched. A thread in such a state is said to be “pending.” In place of the pending thread, the hardware thread scheduler finds another ready (“non-pending”) thread in the active thread pool, and resumes its execution on the particular hardware thread.

Further, illustrative principles of the invention associate performance requirement characteristics with a software thread, and such performance requirement characteristics are also taken into account when the number and type of active hardware threads are determined.

Still further, illustrative principles of the invention use the “pending” state in the active thread pool in support of event polling, e.g., for I/O or synchronization.

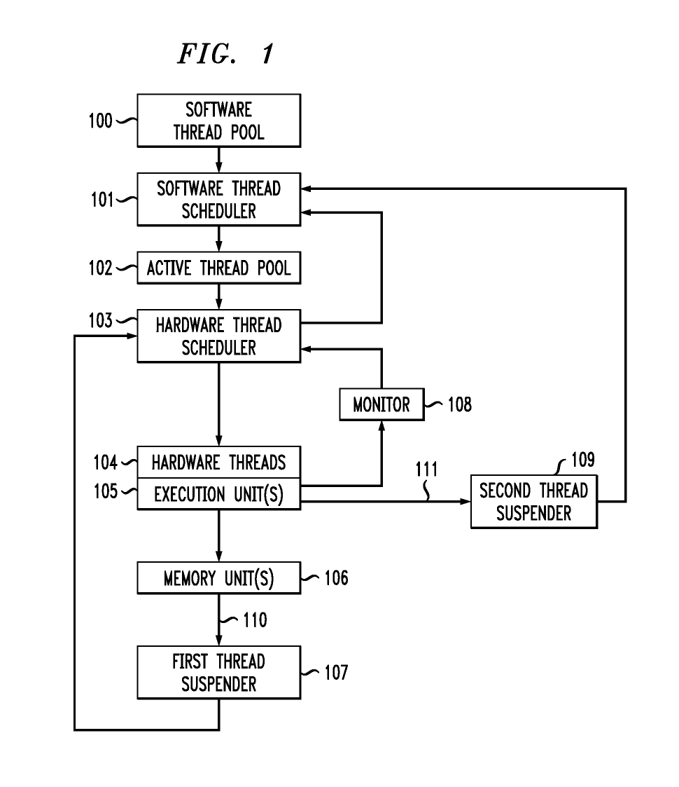

FIG. 1 shows a hardware assisted scheduling system and methodology, according to an embodiment of the invention. Following common convention, a pool of runnable software threads 100 is maintained and processed by a software thread scheduler 101. In an exemplary system, the software thread scheduler can be the operating system scheduler and the organization can be, for example, a prioritized run queue. It is the job of the software thread scheduler 101, based on its underlying scheduling policies (for example, priority, round robin, etc.), to dispatch software threads (tasks) to a set of hardware threads. In existing systems, the number of hardware threads (such as in a simultaneous multithreading scenario) are fixed and it is the job of the software thread scheduler to leave hardware threads idle in an attempt to optimize the system. As indicated in the background section above, this existing software method is typically unable to respond to changing architectural utilization at the rate such changes occur.

Instead, illustrative principles of the invention provide, as shown in the embodiment of FIG. 1, that software threads 100 are not directly dispatched to hardware threads 104, but are added to an active thread pool 102. The active thread pool 102 is comprised of software threads and their associated state (e.g., architected register set) which has been saved in memory, preferably in cache (of the computer system upon which the inventive principles are implemented).

A separate hardware thread scheduler 103 selects active threads based on its specific policy and associates them with hardware threads 104. By doing so, the state of the software thread is brought closer to the execution unit in order to avoid delays. For example, it is common to associate registers with fast static random access memory (SRAM). The hardware threads execute on the one or more execution units 105. As referred to herein, “execution units” are functional parts of the central processing unit (CPU) of the computer system upon which the inventive principles are implemented, while “memory units” are functional parts of the overall memory of the subject computer system.

In contrast to existing multi-threading technology where a hardware thread simply stalls, advantageously in accordance with illustrative principles of the invention, when a unit stalls for a prolonged period of time due to one of a first type of exception 110 (e.g., the memory unit 106 recognizes or anticipates a long stall due to an event such as a cache miss, an I/O request, or a lock spin), the thread is suspended by the first thread suspender 107, marked as “waiting for stall completion” and returned to the hardware thread scheduler 103. The hardware thread scheduler 103 can then return the thread to the active thread pool 102 (it is still presumed to be running) and fetch another active thread and dispatch it on the hardware thread 104. Though not explicitly required, an illustrative embodiment of the invention presumes that the state of the active thread (e.g., their architected register set) is efficiently saved in fast memory that provides significantly faster access then to dynamic RAM (e.g., cache).

It is to be appreciated that illustrative principles of the invention contemplate multiple pending states. That is, there are a variety of reasons that would cause a thread to transition from an active state. For example, on a cache miss, a thread transitions from an active state to a “waiting for stall completion,” as mentioned above. By way of another example, on an I/O operation, a thread transitions from active to a “pending I/O” state. By way of further example, when there is a stall on synchronization, a thread transitions from an active to a “waiting on synchronization state.” Given the inventive teachings herein, one of ordinary skill in the art will realize many other possible examples of pending states and how the scheduler would react to a thread in any given pending state.

Note that when the first type of exception is encountered, the “pending” thread can then be returned to the hardware thread that it was originally assigned to (or another hardware thread) after the event which caused its return to the active thread pool is cleared.

Further, a second type of exception 111 (e.g., floating point exceptions, illegal instruction, page faults) requires intervention by the system software, and thus, threads that raise one such second type of exception 111 are suspended by the second thread suspender 109 and returned to the software thread scheduler 101 which will take an appropriate action dependent upon the type of exception. For example, on a page fault exception, the operating system will initiate an I/O operation to retrieve the referenced page, and will place the thread in a suspended state. Later, upon completion of the I/O operation, the operating system will reschedule the software thread using the software thread scheduler 101. Alternatively, if the page fault is due to an invalid storage reference, the operating system can terminate the thread.

The hardware thread scheduler 103 also dispatches the optimal, or close to optimal, number of active threads into the execution units 105. However, as described in the background section above, it is undesirable to “load” the execution units with so much work that the resources of the execution units (e.g., integer unit, floating point unit, load/store pipeline, etc.) are overcommitted and the threads start to stall based on resource thrashing that go beyond the stalls related to reach memory.

Accordingly, illustrative principles of the invention utilize a monitor 108 that continuously monitors the overall performance of the system. It is to be appreciated that the monitor 108 can be part of each execution unit 105 or it can be a separate element of the computer system (for ease of reference, it is shown in FIG. 1 as a separate element). The IPC (instructions per cycle) of all threads is an example of a well-established normalized metric to characterize the overall performance and throughput of a set of threads while progressing on a given computer system architecture. Moreover, each thread can maintain its own IPC number, but it should be understood that due to the interdependencies on the resources, the IPC can and will be influenced by the other running thread.

The monitor 108 continuously provides the IPC number(s) to the hardware thread scheduler 108, which then decides whether to dispatch more or fewer active threads from the active thread pool 102. Another active thread can be dispatched as long as the number of dispatched active threads has not yet reached the number of hardware threads supported by the execution unit. The hardware thread scheduler 130 will typically attempt to schedule more threads until a degradation of performance is observed at which point the number of executing threads is reduced. Reduction is typically performed when a hardware thread is stalled, at which point it is returned to the active thread pool 102, rather than being continuously associated with the hardware thread resources and instantly redispatched when the stall completes.

Metrics other than IPC may be used in alternative embodiments of the invention (such as, for example, cache miss rates, cache sharing rates, issue slot utilization), with statistics associated with each active thread by the monitor 108, and used to better schedule execution resources by the hardware thread selector 103.

It is to be appreciated that, in one illustrative embodiment, the hardware thread scheduler 103 is comprised of a set of hardware resources such as finite state machines, combinatorial logic, latches and memories, including interfaces to the memory in which the active thread pool 102 resides, as well as interfaces to the hardware threads 104 allowing any software thread to be assigned and its execution initiated. In concert, these hardware resources monitor the set of threads in the active thread pool, the status of hardware threads 104 and execution units 105 and monitor 108. In response to changes in this state, metadata is written into the active thread pool 102, architectural state is retrieved from the hardware threads and saved in the active thread pool, and new threads are assigned on available hardware threads.

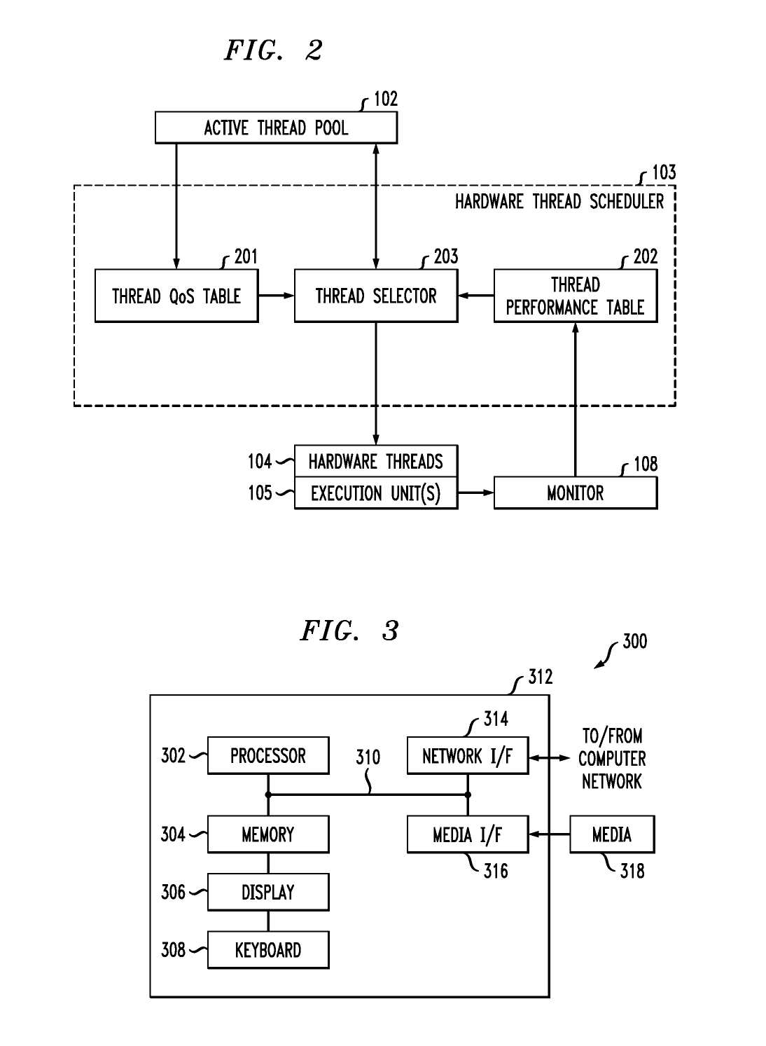

FIG. 2 shows a hardware assisted scheduler, according to an embodiment of the invention. That is, FIG. 2 illustrates exemplary details of the hardware thread scheduler 103 in FIG. 1. Thus, reference will be made to other elements shown in FIG. 1 with which the hardware thread scheduler 103 interacts.

As shown in the hardware thread scheduler 103, associated with each active thread is an entry in a thread quality-of-service (QoS) table 201. Each entry in table 201 specifies performance goals of the corresponding active thread. For example, it may be desirable to specify a target IPC for a particular thread. Further, the monitor (recall from FIG. 1) continuously updates entries in a thread performance table 202 for executing hardware threads, e.g., with the recent IPC information for the executing hardware threads. A thread selector 203 takes these performance characteristics (i.e., entries from table 201 and entries from table 202) into account when deciding the number of executing hardware threads and which active thread to dispatch.

Furthermore, illustrative principles of the invention provide efficient support of event notification. In various situations, a thread may seek to suspend itself pending the occurrence of a certain event, typically in response to a specific memory location being written (e.g., the completion of a direct memory access (DMA) write by an I/O device, the release of a lock, or the release of a barrier). Such event notification can be supported via the pending state in the active thread pool 102 by associating that specific memory address with the pending state. A thread may request that it be set to pending until the specific location is written, at which point the monitor 108 will transition the thread's state from the pending state to the active state. Various embodiments of this solution may be implemented in a straightforward manner. By way of example only, in one embodiment, a cache block is marked indicating that a pending thread is waiting on the block, which is used to notify the monitor 108 that the block was written. If a block is evicted due to capacity, the monitor 108 may be allowed to spuriously awake the pending thread (which would then test the wait condition again). By way of further example, in another embodiment, the monitor 108 includes a Bloom filter to monitor pending memory locations, shielding itself from cache capacity issues.

As will be appreciated by one skilled in the art, aspects of the present invention may be embodied as a system, apparatus, method or computer program product. Accordingly, certain aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring again to FIGS. 1 and 2, the diagrams in the figures illustrate the architecture, functionality, and operation of possible implementations of systems, methods and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

Accordingly, techniques of the invention, for example, as depicted in FIGS. 1 and 2, can also include, as described herein, providing a system, wherein the system includes distinct modules (e.g., modules comprising software, hardware or software and hardware). By way of example only, the modules may include, but are not limited to, a software thread pool, a software thread scheduler, an active thread pool, a hardware thread scheduler, a thread QoS table, a thread selector, a thread performance table, a monitor, one or more execution units, one or more memory units, a first thread suspender and a second thread suspender. These and other modules may be configured, for example, to perform the steps described and illustrated in the context of FIGS. 1 and 2.

One or more embodiments can make use of software running on a general purpose computer or workstation. It is to be understood that the computer architecture of FIG. 3 may be considered to generally represent a computer system with one or more compute cores that include various hardware resources such as, but not limited to, pipelines, integer units, memory caches, load store queues, etc.

With reference to FIG. 3, such an implementation 300 employs, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, keyboard or mouse), and one or more mechanisms for providing results associated with the processing unit (for example, display or printer).

The processor 302, memory 304, and input/output interface such as display 306 and keyboard 308 can be interconnected, for example, via bus 310 as part of a data processing unit 312. Suitable interconnections, for example, via bus 310, can also be provided to a network interface 314, such as a network card, which can be provided to interface with a computer network, and to a media interface 316, such as a diskette or CD-ROM drive, which can be provided to interface with media 318.

A data processing system suitable for storing and/or executing program code can include at least one processor 302 coupled directly or indirectly to memory elements 304 through a system bus 310. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 308 for making data entries; display 306 for viewing input and output information; pointing device for selecting and entering data and user feedback; and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 312 as shown in FIG. 3) running a server program. It will be understood that such a physical server may or may not include a display and keyboard. That is, it is to be understood that the components shown in FIGS. 1 and 2 may be implemented on one server or on more than one server.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer system, comprising:
a first pool for maintaining a set of executable software threads;
a first scheduler;
a second pool for maintaining a set of active software threads; and
a second scheduler;
wherein the first scheduler assigns a subset of the set of executable software threads to the set of active software threads and the second scheduler dispatches one or more threads from the set of active software threads to a set of hardware threads for execution.

2. The computer system of claim 1, wherein the number of active software threads in the set of active software threads is greater than the number of hardware threads in the set of hardware threads.

3. The computer system of claim 1, wherein the second scheduler is implemented in hardware and selects one or more active software threads from the second pool and schedules the one or more active software threads for execution on one or more of the hardware threads.

4. The computer system of claim 1, wherein, when a given active software thread that is dispatched to a given hardware thread encounters a given first type of exception, the given active software thread is returned to the second pool by the second scheduler.

5. The computer system of claim 4, wherein the second scheduler dispatches another active software thread from the second pool to the given hardware thread for execution in place of the returned active software thread.

6. The computer system of claim 5, wherein the returned active software thread is redispatched by the second scheduler from the second pool to a given hardware thread when the given first type of exception is cleared.

7. The computer system of claim 4, wherein, when a given active software thread that is dispatched to a given hardware thread encounters a given second type of exception, the given active software thread is returned to the first scheduler for disposition.

8. The computer system of claim 1, wherein the first scheduler is part of an operating system of the computer system.

9. The computer system of claim 1, further comprising a monitor operatively coupled to the second scheduler for providing performance data to the second scheduler, wherein the performance data comprises data associated with the execution of one or more active software threads on one or more hardware threads.

10. The computer system of claim 9, wherein the second scheduler uses at least a portion of the performance data to decide which active software threads in the second pool to dispatch to the hardware threads.

11. The computer system of claim 10, wherein the second scheduler also uses a quality-of-service level associated with each thread to decide which active software threads in the second pool to dispatch to the hardware threads.

12. A method, comprising:
maintaining, in a computer system, a first pool comprising a set of executable software threads; and
maintaining, in the computer system, a second pool comprising a set of active software threads;
wherein a first scheduler of the computer system assigns a subset of the set of executable software threads to the set of active software threads and a second scheduler of the computer system dispatches one or more threads from the set of active software threads to a set of hardware threads for execution.

13. The method of claim 12, wherein the number of active software threads in the set of active software threads is greater than the number of hardware threads in the set of hardware threads.

14. The method of claim 12, wherein, when a given active software thread that is dispatched to a given hardware thread encounters a given first type of exception, the method further comprising the second schedule returning the given active software thread to the second pool.

15. The method of claim 14, further comprising the second scheduler dispatching another active software thread from the second pool to the given hardware thread for execution in place of the returned active software thread.

16. The method of claim 15, further comprising the second scheduler redispatching the returned active software thread from the second pool to a given hardware thread when the given first type of exception is cleared.

17. The method of claim 14, wherein, when a given active software thread that is dispatched to a given hardware thread encounters a given second type of exception, the method further comprises the given active software thread being returned to the first scheduler for disposition.

18. The method of claim 12, further comprising:
the second scheduler obtaining performance data, wherein the performance data comprises data associated with the execution of one or more active software threads on one or more hardware threads; and
the second scheduler using at least a portion of the performance data to decide which active software threads in the second pool to dispatch to the hardware threads.

19. The method of claim 18, wherein the second scheduler also uses a quality-of-service level associated with each thread to decide which active software threads in the second pool to dispatch to the hardware threads.

20. A hardware-implemented scheduling apparatus, comprising:
a performance data store for storing performance data associated with the execution of one or more software threads on one or more hardware threads;
a quality-of-service data store for storing data associated with one or more software threads; and
a software thread selector;
wherein the software thread selector uses data from at least one of the performance data store and the quality-of-service data store to select a given software thread for scheduling on a given hardware thread.
